(19) United States
(12) Patent Application Publication
(10) Pub. No.: US 2008/0239132 A1
(43) Pub. Date: Oct. 2, 2008

(54) IMAGE DISPLAY UNIT, IMAGE TAKING APPARATUS, AND IMAGE DISPLAY METHOD

(75) Inventor: Masaki Kohama, Miyagi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/055,403

(22) Filed: Mar. 26, 2008

(30) Foreign Application Priority Data
Mar. 28, 2007 (JP) 2007-084822

(51) Int. Cl. H04N 5/222; G09G 5/00; G06F 3/041

(52) U.S. Cl. 348/333.01; 345/1.1; 345/173; 348/E05.022

(57) ABSTRACT

There is provided an image display unit having a main screen and one or more sub-screens, wherein two or more zoom areas are designated, and images of the designated zoom areas are displayed on the sub-screens. The image display unit includes: a first display section that displays images on the main screen; a designating section that designates a desired place on the main screen by an operation; and a second display section that displays on one of the sub-screens an image in a derived area including the place designated by the designating section, of the images displayed on the main screen.

### BACKGROUND OF THE INVENTION

1. Field of the Invention

The present invention relates to an image display unit having a main screen and one or more sub-screens, an image taking apparatus having such an image display unit, and an image display method.

2. Description of the Related Art

For a recent digital camera, there is a lot of one that an image display unit is prepared for because the display is used instead of the viewfinder. Preparation of the image display unit makes it possible to perform a display in such a manner that a derived area is set partially of an image on a display screen, and an image of the derived area thus set is displayed on the display screen with an enlargement by an electronic zoom. Recently, as making an image sensor a high pixel advances, making LCD and the like composing a display screen a high-resolution is advanced. As a result, even if a part of the image is enlarged and displayed on the display screen through the electronic zoom, a clear image can be displayed.

Some of the recent image taking apparatus have an image display unit having a main screen and a sub-screen, wherein when a desired area of an image on the main screen is designated, a derived area for the electronic zoom through encircling the designated area with a frame is displayed on the main screen, and an image of the area encircled with the frame is subjected to the electronic zoom and then displayed on the sub-screen (for instance, refer to Japanese Patent Application Laid Open Gazette TokuKai Hei. 05-260352, Japanese Patent Application Laid Open Gazette TokuKai Hei. 06-165012, and Japanese Patent Application Laid Open Gazette TokuKai 2001-45407). When a whole image and an image obtained through an enlargement of a part of the whole image are displayed on the main screen and the sub-screen, which are used instead for the viewfinder using technologies disclosed in the above-referenced Japanese Patent documents, respectively, it is possible to perform a photography, for instance, in such a way that while looking about the entire play of children who are playing soccer on the main screen, only the play of my child who exists in the sub-screen is individually seen on the sub-screen, and it takes a picture at a good opportunity for a photograph. Thus, according to the image taking apparatuses disclosed in the above-referenced Japanese Patent documents, in order to obtain more clear display for the enlarged image on the on the sub-screen, focusing on the derived area is done and the exposure adjustment is done the derived area.

According to the image taking apparatuses disclosed in the above-referenced Japanese Patent documents, however, only one derived area for the electronic zoom can be set in the image on the main screen.

### SUMMARY OF THE INVENTION

In view of the foregoing, it is an object of the present invention to provide an image display unit having a main screen and one or more sub-screens, wherein two or more zoom areas are designated, and images of the designated zoom areas are displayed on the sub-screens, an image taking apparatus having such an image display unit, and an image display method.

To achieve the above-mentioned objects, the present invention provides a first image display unit having a main screen and one or more sub-screens, the image display unit comprising:

a first display section that displays images on the main screen;

a designating section that designates a desired place on the main screen by an operation; and

a second display section that displays on one of the sub-screens an image in a derived area including the place designated by the designating section, of the images displayed on the main screen.

According to the image display unit of the present invention as mentioned above, when the designating section designates a desired place of an image displayed on the main screen, the second display section displays on one of the sub-screens an image in a derived area including the place designated by the designating section, of the images displayed on the main screen. Further, according to the image display unit of the present invention as mentioned above, when the designating section designates two or more places, the second display section displays on one or more sub-screens images in derived areas including the places designated by the designating section.

In other words, according to the image display unit of the present invention as mentioned above, when the designating section designates two or more electronic zoom areas, individual images of the designated electronic zoom areas are zoomed and displayed on the individual sub-screens.

In the image display unit according to the present invention as mentioned above, it is preferable that the main screen is a touch panel, and the designating section designates a touched place on the main screen through a finger touch on the main screen.

This feature makes it possible for a user to designate the derived areas that are electronic zoom areas with one touch operation by a finger, while looking images displayed on the main screen.

In the image display unit according to the present invention as mentioned above, it is preferable that the first display section indicates on the image displayed on the main screen the derived area displayed on the sub-screen, of the image displayed on the main screen.

This feature makes it possible for a user to confirm on the main screen a portion of an image now zoomed and displayed on the sub-screen, while looking images displayed on the main screen.

In the image display unit according to the present invention as mentioned above, it is preferable that the designating section designates movement and enlargement/reduction of the derived area in accordance with touch and movement of a finger on the derived area,

the first display section indicates on the image displayed on the main screen the derived area after movement or enlargement/reduction in accordance with movement or enlargement/reduction of the derived area, and

the second display section displays the image in the derived area after movement and enlargement/reduction in accordance with movement or enlargement/reduction of the derived area.

According to the image display unit of the present invention as mentioned above, when the designating section designates movement and enlargement/reduction of the derived area, the first display section indicates on the main screen the state of movement or enlargement/reduction of the derived areas for the electronic zoom, and the second display section displays the image in the derived area after movement and enlargement/reduction in accordance with movement or enlargement/reduction of the derived area.

This feature makes it possible for a user to promptly perform both the set up of the zoom position and the set up of the zoom magnification with the simple operation such as a finger touch.

In the image display unit according to the present invention as mentioned above, it is preferable that the image display unit has a plurality of sub-screens each of which is a touch panel, and the second display section displays on the sub-screen designated by a finger touch of the plurality of sub-screens an image in the derived area including the place designated by the designating section, of the images displayed on the main screen.

This feature makes it possible for a user to designate easily through one touch operation a position for an electronic zoom of an image, while looking images displayed on the main screen, and display an image in the derived area designated with further one touch operation on the designated sub-screen.

To achieve the above-mentioned objects, the present invention provides a second image display unit having a main screen and one or more sub-screens, the image display unit comprising:

a first display section that displays images on the main screen;

a face detection section that detects a face in an image displayed on the main screen; and

a second display section that displays on one of the sub-screens an image in a derived area including the face detected by the face detection section, of the images displayed on the main screen.

According to the second image display unit of the present invention as mentioned above, it is possible to display on one or more sub-screens images in the derived area including the face detected by the face detection section.

This feature makes it possible to confirm persons in the event that there are two or more persons in the images displayed on the main screen, since individual persons are displayed in the sub-screens.

Mounting the first image display unit or the second image display unit of the present invention on an image taking apparatus makes it possible to improve the operability of the image taking apparatus.

To achieve the above-mentioned objects, the present invention provides a first image taking apparatus that forms an image of a subject on an imaging device to create an image representative of the subject, wherein the image taking apparatus has a main screen and one or more sub-screens, the image taking apparatus comprising:

a first display section that displays images created by the imaging device on the main screen;

a designating section that designates a desired place on the main screen by an operation; and

a second display section that displays on one of the sub-screens an image in a derived area including the place designated by the designating section, of the images displayed on the main screen.

In the first image taking apparatus according to the present invention as mentioned above, it is preferable that the main screen is a touch panel, and the designating section designates a touched place on the main screen through a finger touch on the main screen.

In the first image taking apparatus according to the present invention as mentioned above, it is preferable that the first display section indicates on the image displayed on the main screen the derived area displayed on the sub-screen, of the image displayed on the main screen.

In the first image taking apparatus according to the present invention as mentioned above, it is preferable that the designating section designates movement and enlargement/reduction of the derived area in accordance with touch and movement of a finger on the derived area,

the first display section indicates on the image displayed on the main screen the derived area after movement or enlargement/reduction in accordance with movement or enlargement/reduction of the derived area, and

the second display section displays the image in the derived area after movement and enlargement/reduction in accordance with movement or enlargement/reduction of the derived area.

In the first image taking apparatus according to the present invention as mentioned above, it is preferable that the image display unit has a plurality of sub-screens each of which is a touch panel, and the second display section displays on the sub-screen designated by a finger touch of the plurality of sub-screens an image in the derived area including the place designated by the designating section, of the images displayed on the main screen.

To achieve the above-mentioned objects, the present invention provides a second image taking apparatus that forms an image of a subject on an imaging device to create an image representative of the subject, wherein the image taking apparatus has a main screen and one or more sub-screens, the image taking apparatus comprising:

a first display section that displays images created by the imaging device on the main screen;

a face detection section that detects a face in an image displayed on the main screen; and

a second display section that displays on one of the sub-screens an image in a derived area including the face detected by the face detection section, of the images displayed on the main screen.

In the first image taking apparatus and the second image taking apparatus according to the present invention as mentioned above, it is preferable that the image taking apparatus has two or more sub-screens, and the image taking apparatus further comprises a focus adjusting section that performs focusing on two or more derived areas displayed on said two or more sub-screens, respectively, to focus on the closest derived area of said two or more derived areas.

This feature makes it possible to obtain an image in which the focus is adjusted in such a way that when a photography is performed while a user is looking both the main screen and the sub-screen, it is focused on the closest derived area of each of said two or more derived areas, so that out-of focus of the backward side following the focus is reduced.

In the first image taking apparatus and the second image taking apparatus according to the present invention as mentioned above, it is acceptable that the image taking apparatus has two or more sub-screens, and the image taking apparatus further comprises a focus adjusting section that performs focusing on two or more derived areas displayed on said two or more sub-screens, respectively, to focus on a distance offering an equivalent circle of confusion on the closest derived area and the farthest derived area of said two or more derived areas.

In the first image taking apparatus and the second image taking apparatus according to the present invention as mentioned above, it is acceptable that the image taking apparatus has two or more sub-screens, and the image taking apparatus further comprises a focus adjusting section that performs focusing on two or more derived areas displayed on said two or more sub-screens, respectively, to focus on a distance farther than the closest derived area of said two or more derived areas in a range that the closest derived area is in a predetermined permissible circle of confusion.

In the first image taking apparatus and the second image taking apparatus according to the present invention as mentioned above, it is acceptable that the image taking apparatus has two or more sub-screens, and the image taking apparatus further comprises an aperture adjusting section that adjusts an aperture so that said two or more derived areas is in a predetermined permissible circle of confusion.

In the first image taking apparatus and the second image taking apparatus according to the present invention as mentioned above, it is acceptable that the image taking apparatus further comprises a white balance adjustment section that adjusts a white balance in accordance with an image displayed on the main screen.

This feature makes it possible to adjust the white balance of the image of the derived area displayed on the sub-screen in accordance with the white balance of an image displayed on the main screen, that is, the entire image.

In the first image taking apparatus and the second image taking apparatus according to the present invention as mentioned above, it is acceptable that the image taking apparatus further comprises a standard color storage section that stores a standard color for a white balance adjustment in accordance with an image displayed on the sub-screen.

This feature makes it possible to perform the white balance adjustment in such a way that for instance, when the white portion suitable for performing white balance exists in the image displayed on the main screen, the standard color storage section stores a standard color based on the white of the portion.

In the first image taking apparatus and the second image taking apparatus according to the present invention as mentioned above, it is acceptable that the image taking apparatus further comprises two or more image taking sections that focus on the main screen and said one or more sub-screens and perform photography for two or more images adjusted in exposure.

To achieve the above-mentioned objects, the present invention provides an image display method of displaying images onto a main screen and one or more sub-screens, the image display method comprising:

first display step of displaying images on the main screen;

designating step of designating a desired place on the main screen by an operation; and

second display step of displaying on one of the sub-screens an image in a derived area including the place designated in the designating step, of the images displayed on the main screen.

According to the image display method of the present invention as mentioned above, it is possible to display images of the derived areas designated in plural places on the sub-screens.

In the above-mentioned present invention, the main screen and the sub-screen may be separate screens which are physically divided, or alternately the main screen and the sub-screen may be ones where individual areas on one screen which is a physically united screen are divided properly for use into the main screen and the sub-screen referred to in the present invention.

### BRIEF DESCRIPTION OF THE DRAWINGS

FIG. 1 is a perspective view of a digital camera, which is one embodiment of an image taking apparatus of the present invention.

FIG. 2 is a functional block diagram of the electrical system of the digital camera 1 of FIG. 1.

FIG. 3 is a flowchart useful for understanding procedure of display processing of CPU 100 upon receipt of contact of fingers with a first sub-screen 130B or a second sub-screen 130B.

FIG. 4 is an explanatory view useful for understanding variation of display states of a main screen 130A, the first sub-screen 130B, and the second sub-screen 130B where the CPU 100 executes processing of FIG. 3.

FIG. 5 is an explanatory view useful for understanding a second embodiment.

FIG. 6 is an explanatory view useful for understanding a second embodiment.

FIG. 7 is an explanatory view useful for understanding a second embodiment.

FIG. 8 is an explanatory view useful for understanding effects where photography is carried out through focusing on the closest derived area of two derived areas.

FIG. 9 is an explanatory view useful for understanding processing of the CPU 100 where a focus lens is disposed at the position of FIG. 8.

FIG. 10 is an explanatory view useful for understanding an example where individual permissible circles of two derived areas overlap each other in a state that an aperture opens before stopping down.

FIG. 11 is an explanatory view useful for understanding processing of the CPU 100.

FIG. 12 is an explanatory view useful for understanding white balance processing of an image processing circuit 122.

FIG. 13 is an explanatory view useful for understanding an example where a digital camera has a function of custom white balance (CWB).

FIG. 14 is a flowchart useful for understanding procedure of image taking processing of the CPU 100 where the custom white balance is carried out.

FIG. 15 is an explanatory view useful for understanding a structure of a digital camera having two or more images taking sections referred to in the present invention.

FIG. 16 is a flowchart useful for understanding processing where a multi-page is carried out with the digital camera of FIG. 15.

### DETAILED DESCRIPTION OF PREFERRED EMBODIMENTS

Embodiments of the present invention will be described with reference to the accompanying drawings.

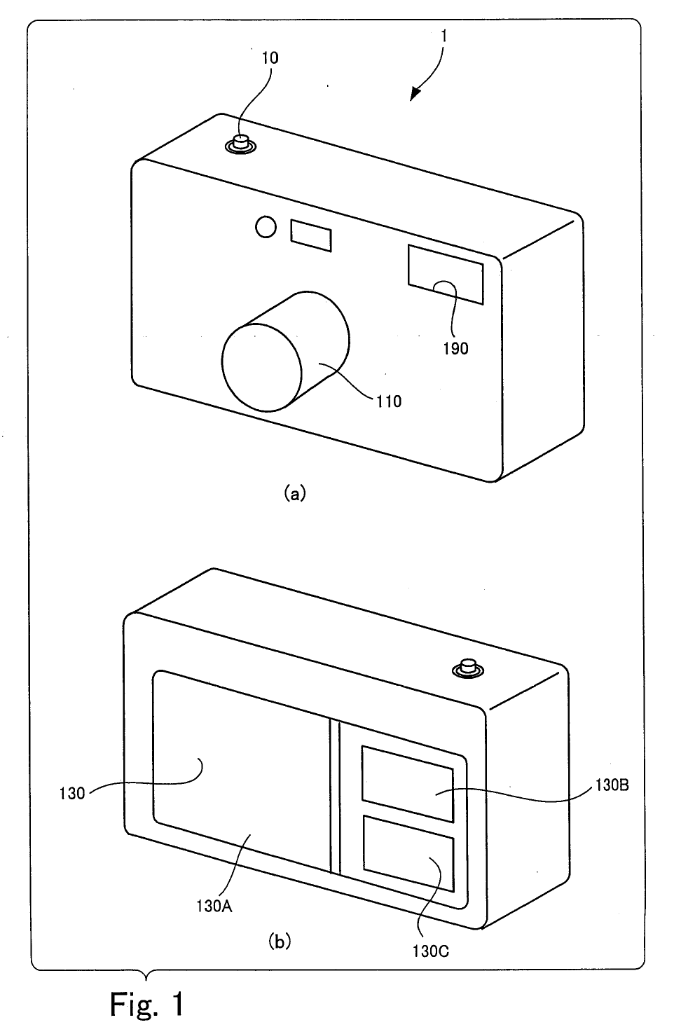

FIG. 1 is a perspective view of a digital camera, which is one embodiment of an image taking apparatus of the present invention.

FIG. 1 shows a perspective view of a digital camera 1 having an image display unit referred to in the present invention.

A part (a) of FIG. 1 shows a perspective view of the digital camera 1 looking from the upper side of the front. A part (b) of FIG. 1 shows a perspective view of the digital camera 1 looking from the upper side of the back.

As seen from the part (a) of FIG. 1, the digital camera 1 has a lens barrel 110 at the center of the body of the digital camera 1, and a light luminescence window 190 is prepared at the upper side of right of the lens barrel 110. A release button 10 is prepared on the top of the body of the digital camera 1. As seen from the part (b) of FIG. 1, at the back side of the digital camera 1, there are provided a main screen 130A, and two sub-screens 130B and 130C. Those three screens 130A, 130B and 130C are each provided with an electrostatic sensor 130 in its entirety to form a touch panel. According to the present embodiment, two sub-screens are prepared, and thus in the following explanation, the sub-screen 130B and the sub-screen 130C will be denoted by a first sub-screen and a second sub-screen, respectively. Further, according to the present embodiment, those three screens 130A, 130B and 130C are constructed of LED, and thus in the following explanation, it may happen that reference numbers 130A, 130B and 130C are applied to LED constituting the main screen, LED constituting the first sub-screen, and LED constituting the second sub-screen, respectively.

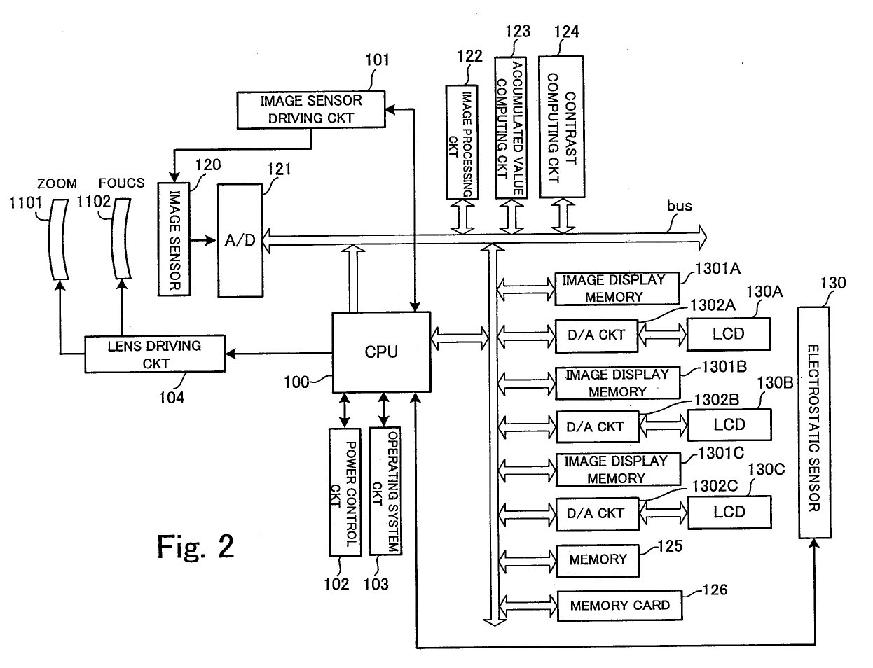

FIG. 2 is a functional block diagram of the electrical system of the digital camera 1 of FIG. 1.

As mentioned above, the digital camera 1 of FIG. 1 is provided with an image display unit. The function as the digital camera is implemented by image taking lenses 1101 and 1102, an image sensor 120, an image sensor driving circuit 101, A/D 121, an image processing circuit 122, an accumulated value computing circuit 123, a contrast computing circuit 124, and a lens driving circuit 104. The function as the image display unit is implemented by three image display memories 1301A, 1301B, and 1301C, three D/A circuits 1302A, 1302B, and 1302C, and three LED's 130A, 130B, and 130C. According to the present embodiment, as mentioned above, there is adopted a touch panel as the designation section referred to in the present invention, and the electrostatic sensor 130 is disposed all over the surfaces of three LCD's 130A, 130B, and 130C.

The digital camera 1 is controlled in all operation by a CPU 100. The CPU 100 receives operating signals generated from an operating system circuit 103 including an electric power switch (not illustrated) and a release button 10, and operating signals generated from the electrostatic sensor 130. Electric power from a battery (not illustrated) is always supplied to the CPU 100. When the electric power switch (not illustrated) turns on, electric power is supplied via a power control circuit 102 to individual circuits so that the CPU 100 starts the control of the operation of the digital camera 1 in its entirety.

First of all, there will be explained the operation of the digital camera 1 of FIG. 1 as an image taking apparatus.

According to the present embodiment, it is assumed that the image sensor 120 is of high pixel number and high frame rate.

The CPU 100 instructs an image sensor driving circuit 101 to cause the image sensor 120 to generate images at prescribed intervals. The thus generated images are output to the A/D 121. At that time, a high pixel number of image signal is output. The A/D 121 after the image sensor 120 receives an analog image signal output from the image sensor 120 to perform the conversion to a digital image signal. The digital image signal, which is output from the A/D 121, is stored via a data bus “bus” in a frame memory of the image processing circuit 122. The digital image signal, which is stored in the frame memory of the image processing circuit 122, is supplied to the accumulated value computing circuit 123 and the contrast computing circuit 124.

The image processing circuit 122 performs the signal processing for the image signal. The digital image signal, which is subjected to the signal processing, is supplied to the image display memory 1301A of the LED 130A constituting the main screen. An image is displayed on the LED 130A in accordance with the image signal of the image display memory 1301A.

At that time, since it is undesired that the image out of focus and exposure is displayed on the LCD 130A, the CPU 100 instructs the lens driving circuit 104 to move the focus lens 1102 to a focus position in accordance with a detection result of the focus position by the contrast computing circuit 124, and instructs the image sensor driving circuit 101 to adjust the shutter speed of the electronic shutter in accordance with the exposure detected by the accumulated value computing circuit 123.

Thus, it is possible to always display on the main screen 130A the image that is in focus and exposure.

When the release button 10 operates, the CPU 100 instructs the image sensor driving circuit 101 to cause the image sensor 120 to start the exposure in the timing when the release button 10 is depressed and terminate the exposure after the lapse of a predetermined shutter time, and then instructs the image sensor driving circuit 101 to generate an image read signal so that the image, which is subjected to the exposure, is output from the image sensor 120 to the A/D 121. The image signal, which is converted into the digital signal by the A/D 121, is supplied to the image processing circuit 122. The image signal, which is subjected to the image processing with the image processing circuit 122, is recorded on a memory 125 or a memory card 126.

Next, there will be explained the image display unit.

The image display unit according to the present embodiment comprises: three LCD 130A, LCD 130B, and LCD 130C; three D/A conversion circuits 1302A, 1302B, and 1302C for digital image signals to analog signals to display images on the main screen, the first sub-screen, and the second sub-screen, which are constituted of three LCD 130A, LCD 130B, and LCD 130C, respectively; and three display memories 1301A, 1301B, and 1301C, which are used as display buffers, when images are displayed on the main screen, the first sub-screen, and the second sub-screen, respectively. Further, according to the present embodiment, the electrostatic sensor 130 is disposed on the surfaces of three LCD 130A, LCD 130B, and LCD 130C so that a touch panel, which constitutes an example of the designation section referred to in the present invention, is formed all over the surfaces of three LCD 130A, LCD 130B, and LCD 130C. The electrostatic sensor 130 is the film one and is arranged to cover the surfaces of three LCD 130A, LCD 130B, and LCD 130C. The electrostatic sensor 130 is constructed in such a way that when one's finger comes in contact with either of part of the surfaces of three LCD 130A, LCD 130B, and LCD 130C, a signal indicative of coordinates in the part that comes in contact is output from the electrostatic sensor 130. When the CPU 100 receives the signal indicative of the coordinates, the CPU 100 detects the location on the display screen composed by the main screen LCD 130A, the first sub-screen LCD 130B, and the second sub-screen LCD 130C, with which the finger comes in contact.

According to the present embodiment, there is provided an arrangement in which the CPU 100 starts the processing upon receipt of the contact of the finger with anyone of the first sub-screen LCD 130B, and the second sub-screen LCD 130C. Therefore, there will be explained the display processing assuming that the finger comes in contact with the first sub-screen LCD 130B.

According to the present embodiment, the first display section referred to in the present invention comprises the CPU 100, the image display memory 1301A, the D/A circuit 1302A, and the LCD 130A. The second display section referred to in the present invention comprises the CPU 100, the image display memories 1301B and 1301C, the D/A circuits 1302B and 1302C, and the LCD's 130B and 130C.

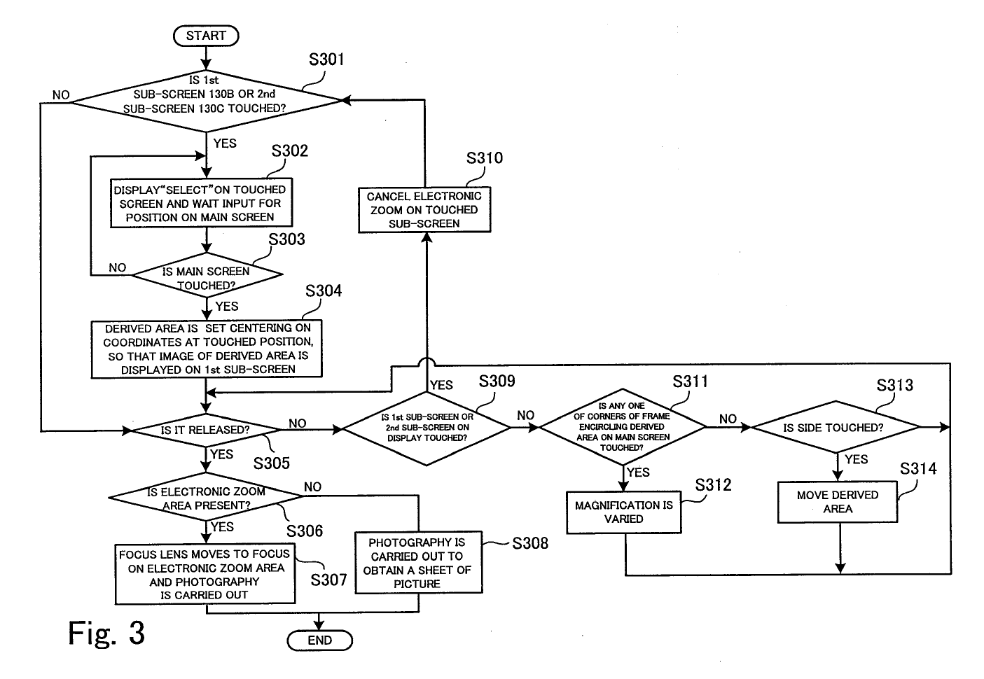

FIG. 3 is a flowchart useful for understanding procedure of display processing of CPU 100 upon receipt of contact of fingers with a first sub-screen 130B or a second sub-screen 130B.

The flowchart of FIG. 3 corresponds to an image display method referred to in the present invention. In the following explanation, it may happen that words of electronic zoom area or zoom area are used in the same meaning as the derived area. Further, since an image of the derived area is derived to perform the zoom processing, it may happen that the zoom processing is referred to as a trimming.

In the step S301, when it is judged that either (for instance, the first sub-screen 130B) of the first sub-screen 130B and the second sub-screen 130C is touched, the process goes to the step S302 in which the word “select” is transferred to an image display memory of the first sub-screen 130B touched so that the word “select” is displayed on the first sub-screen 130B, and waiting an input for a position by the finger touch onto the main screen 130A. In the step S303, when it is judged that any position on the main screen 130A is touched, the process goes to the step S304 in which a derived area is set centering on coordinates at the position touched, so that an image of the derived area is displayed on the first sub-screen 130B.

Then, the program proceeds to the step S305 in which it is judged whether the release button 10 is depressed. In the step S305, when it is decided that the release button 10 is depressed, the process goes to the step S306 in which it is judged whether the electronic zoom area as the derived area is present. In the step S306, when it is decided that the electronic zoom area is present, the process goes to the step S307 in which the focus lens moves so as to focus on the electronic zoom area and the photography is carried out. Thus, the processing is terminated. On the other hand, in the step S306, when it is decided that the electronic zoom area is absent, the process goes to the step S308 in which it focuses on the center and the photography is carried out to obtain a sheet of picture. Thus, the processing is terminated.

On the other hand, in the step S301, it is decided that none of the first sub-screen 130B and the second sub-screen 130C is touched, the process jumps to the step S305 in which when the release button 10 is depressed, the processing of the step S306 to the step S308 is carried out. Thus, the processing is terminated.

In the step S305, when it is decided that the release button 10 is not depressed, the process goes to the step S309 in which it is judged whether the sub-screen in the zoom image display, that is, here the first sub-screen 130B, is touched again. In the step S309, when it is decided that the first sub-screen 130B is touched again, the displayed image is erased and the set up of the derived area of the main screen 130A is released. Thus, the process returns to the step S301 so as to repeat the processing of the step S301 to the step S309.

On the other hand, in the step S309, when it is decided that the sub-screen in the image display, that is, here the first sub-screen 130B is not touched, the process goes to the step S311 in which it is judged whether any one of the corners of the frame encircling the derived area on the main screen 130A is touched. In the step S311, when it is decided that the corner is touched, the process goes to the step S312 in which the magnification (the size of the frame encircling the derived area) is varied, and returns to the step S305 waiting the release operation. In the step S311, when it is decided that the corner is touched, the process goes to the step S313 in which it is judged whether any one of sides of the frame on the main screen 130A is touched. In the step S313, when it is decided that the side is touched, the process goes to the step S314 in which the derived area is moved and returns to the step S305 waiting the release operation. In the step S313 too, when it is decided that the side is not touched, the process returns to the step S305 waiting the release operation.

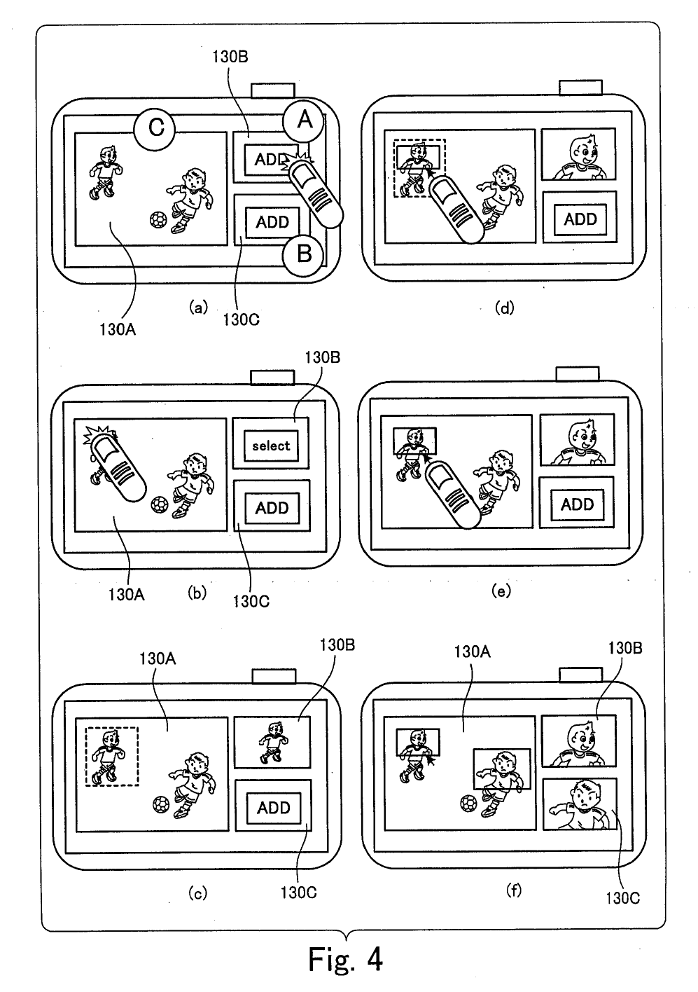

FIG. 4 is an explanatory view useful for understanding variation of display states of a main screen 130A, a first sub-screen 130B, and a second sub-screen 130C where the CPU 100 executes processing of FIG. 3.

FIG. 4 shows states of variations in display of the main screen 130A, the first sub-screen 130B, and the second sub-screen 130C according to the procedure of the flowchart of FIG. 3 in the order of part (a) of FIG. 4, part (b) of FIG. 4, . . . part (f) of FIG. 4.

First of all, as seen in the part (a) of FIG. 4, when the first sub-screen 130B, which offers a waiting screen for waiting a touch operation (a word “ADD” is displayed), is touched, the word “ADD” disappears on the first sub-screen 130B and the word “select” is displayed (the step S302 of FIG. 3), as seen in the part (b) of FIG. 4. In this state, when the main screen 130A is touched to perform the position input, the derived area is indicated with the frame centering on the position, so that the image of the derived area indicated with the frame is displayed on the first sub-screen 130B (the step S304 of FIG. 3), as seen in the part (c) of FIG. 4.

Next, as seen in the part (d) of FIG. 4, when the corner of the frame is touched and dragged, the size or the magnification of the frame of the derived area is altered, so that the magnification of the image on the first sub-screen 130B is altered in accordance with the alteration of the magnification of the frame, as seen in the part (d) of FIG. 4 and the part (e) of FIG. 4. While the flowchart of FIG. 3 does not show it, when any place on an area other than the first derived area, on the main screen 130A, is touched in the state of the part (e) of FIG. 4, a new derived area is set to the touched place as seen in the part (f) of FIG. 4, so that the image on the derived area thus set is displayed on the second sub-screen 130C.

In other words, the touch panel that constitutes the designation section referred to in the present invention designates movements, and enlargement and reduction of the derived area in accordance with touch and movement of the finger to the derived area on the image displayed on the main screen 130A. The first display section indicates the derived area after the movement or enlargement and reduction on the image displayed on the main screen 130A in accordance with the movement or enlargement and reduction of the derived area. The second display section displays the image on the derived area after the movement or enlargement and reduction in accordance with the movement or enlargement and reduction of the derived area.

As mentioned above, according to the present invention, it is possible to implement an image display unit having a main screen and one or more sub-screens, wherein two or more zoom areas are designated, and images of the designated zoom areas are displayed on the sub-screens, an image taking apparatus having such an image display unit, and an image display method.

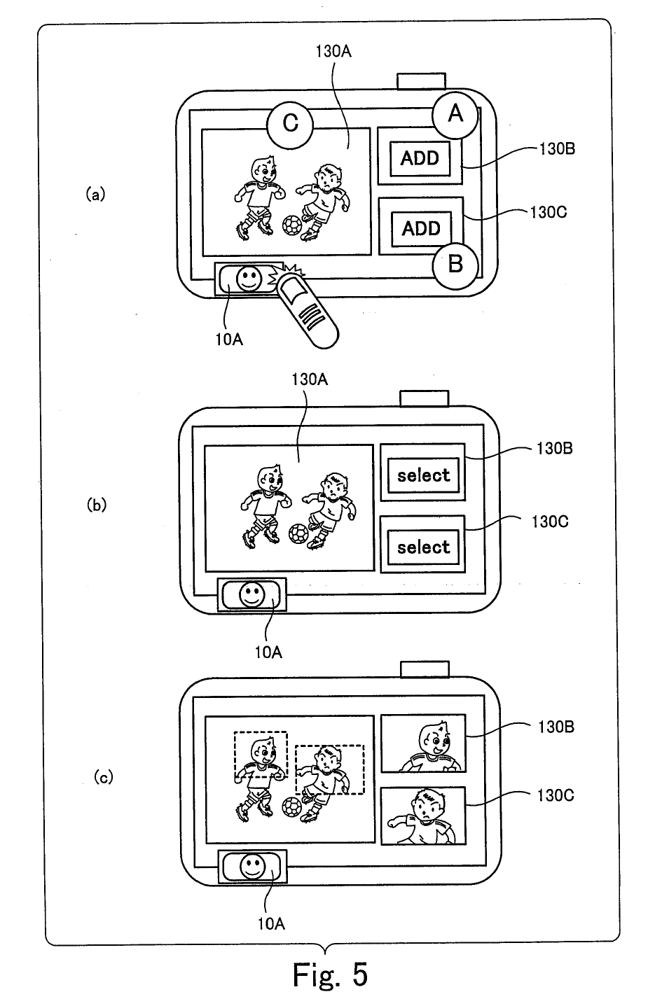

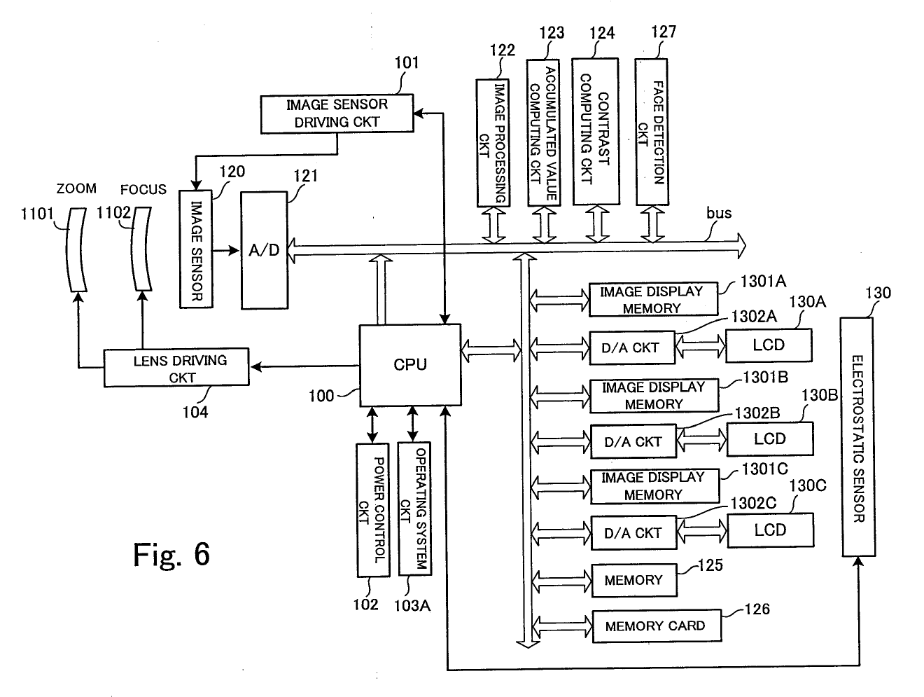

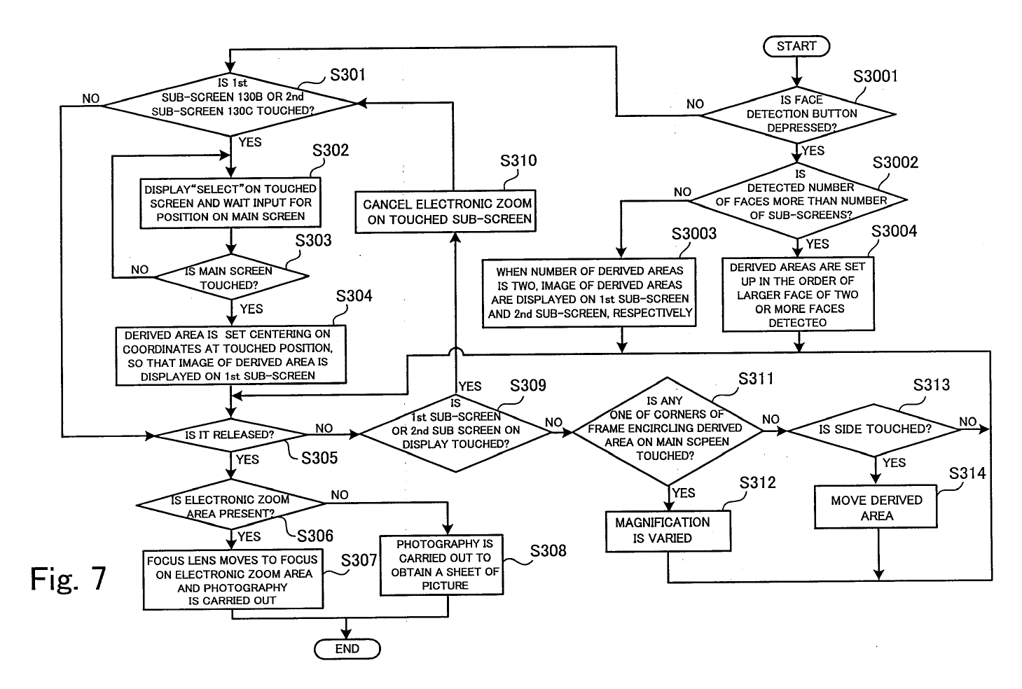

FIG. 5 is an explanatory view useful for understanding a second embodiment. FIG. 6 is an explanatory view useful for understanding a second embodiment. FIG. 7 is an explanatory view useful for understanding a second embodiment.

FIG. 5 shows an example in which the structure of FIG. 4 is modified in the point that a face detection button 10A is added. FIG. 6 shows an example in which the structure of FIG. 2 is modified in the point that a face detection button 10A is added into an operating system circuit 103A, and a face detection circuit 127 is added. FIG. 7 shows a flowchart in which the flowchart of FIG. 3 is modified in the point that processing of step S3001 to step S3004 is added.

According to the embodiment of FIG. 5 to FIG. 7, when the face detection button 10A is depressed, two derived areas are automatically set up to the place of the face detected with the face detection circuit 127, the images of the two derived areas thus set up are displayed on the first sub-screen 130B and the second sub-screen 130C, respectively. On the other hand, when the face detection circuit 127 detects no face, the same processing as the first embodiment is carried out so that the image of the derived area designated on the main screen 130A is displayed on the touched first sub-screen 130B or second sub-screen 130C.

Since the processing from the step S301 to the step S314 of the processing of FIG. 7 is the same as that of FIG. 3, here the processing from the step S3001 to the step S3004 will be explained, and then the function will be explained referring to FIG. 5.

In the step S3001, it is judged whether the face detection button 10A is depressed. When it is decided that face detection button 10A is not depressed, the process goes to the step S301 to execute the processing of the first embodiment from the step S301 to the step S314.

In the step S3001, when it is decided that face detection button 10A is depressed, the process goes to the step S3002 in which it is judged whether the number of faces, which is detected by the face detection circuit 127, is more than the number of sub-screens. In the step S3002, when it is decided that the number of faces is two or less, the process goes to the step S3003 in which a derived area is set up centering on the position of the detected face. In the event that the number of derived areas is two, the images of two derived areas are displayed on the first sub-screen 130B and the second sub-screen 130C, respectively.

In the step S3002, when it is decided that the number of faces is more than two, the process goes to the step S3004 in which derived areas are set up in the order of larger face (that is, one focused in the nearer length) of two or more faces detected by the face detection circuit 127. The images of the set derived areas are displayed on the first sub-screen 130B and the second sub-screen 130C, respectively.

The program proceeds to the step S305 waiting the release operation and performs the processing from the step S305 to the step S314.

When the above-mentioned processing is carried out by the CPU 100, in the event that the face is detected in the subject, the derived area is set up in the periphery of the detected face and the image of the derived area thus set up is automatically enlarged and displayed in the individual sub-screen. It is acceptable to provide such an arrangement.

Incidentally, when the derived area for electronic zoom is designated by touch of the finger, it happens that the image of the derived area is unfocused because the image taking optical system is focused on the center. Thus, according to the digital camera of the first and second embodiment, it is considered to avoid such a situation that the enlarged image through the electronic zoom is out of focus in such a manner that the CPU 100 sets up the focus in the processing of the step S307 so that the camera is focused also on the derived area that is the electronic zoom area.

However, in the event that two or more derived areas are set up, it happens that the focus ranges of the individual derived areas are different from one another. In such a case, set up of the focus backward may bring about a very large out-of-focus on the derived area at the closest side. Thus, in order to obtain evenness of the state of out-of-focus, it is better that the photography is performed through focusing on the derived area at the closest side of the zoom areas.

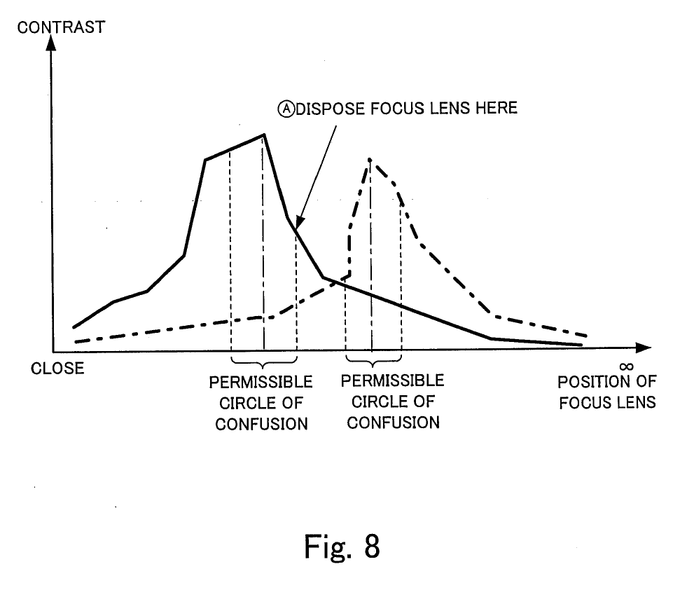

FIG. 8 is an explanatory view useful for understanding effects where photography is carried out through focusing on the closest derived area of two derived areas. FIG. 8 shows a computing result wherein the contrast computing circuit 124 computes contrast for each electronic zoom area while the focus lens moves from the closest side to the infinite-distant side.

As seen from FIG. 8, in the event the focus ranges of the individual derived areas are different from one another, a displacement of the focus lens within a permissible circle of confusion of either one of the derived areas brings about out-of-focus on the other derived area.

In this case, as shown in FIG. 8, focusing on the position wherein the permissible circles of confusion of both the derived areas are substantially the same as one another in size, that is, the distant side far than the closest derived area in a range where the closest derived area of two derived areas is in the permissible circle of confusion, makes it possible to implement evenness of out-of-focus on both the derived areas. In the event that two or more derived areas exist, focusing on the distance offering an equivalent circle of confusion on the closest derived area and the farthest derived area of two or more derived areas makes it possible to implement evenness of out-of-focus on all the derived areas.

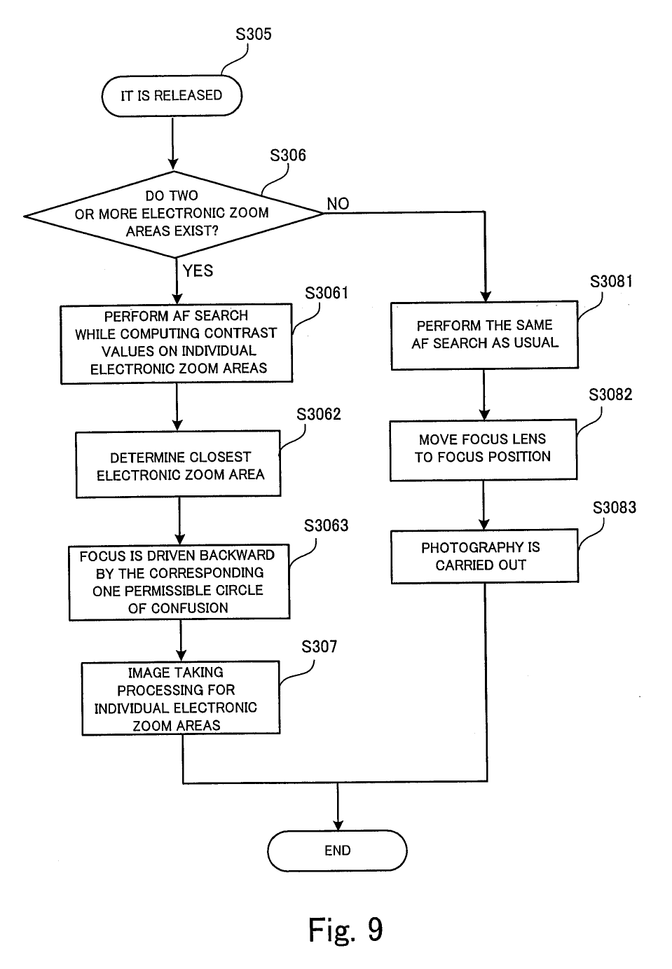

FIG. 9 is an explanatory view useful for understanding processing of the CPU 100 where a focus lens is disposed at the position of FIG. 8. In FIG. 9, there is shown processing following the step S305 of FIG. 3, and processing of step S3061, step S3062 and step S3063 is added. Details of the step S308 of FIG. 3 are shown with division into processing of the step S3081, the step S3082, and the step S3083. In the flowchart, the word “AF search” implies processing for retrieving the focus position by detection of the peak of the contrast while the focus lens moves.

In the step S305, when it is decided that the release button is depressed, the process goes to the step S306 in which it is judged whether there are two or more electronic zoom areas. In the step S306, when it is decided that there are not two or more electronic zoom areas, the process goes to the step S3081 in which the contrast computing circuit 124 computes the contrast of the center of subject while the focus lens 1102 moves. In the step S3082, the focus lens 1102 moves to the focus position in accordance with the computing result of the contrast computing circuit 124. In the step S3083, the photography is carried out and the processing of this flowchart is terminated.

In the step S306, when it is decided that there are two or more electronic zoom areas, the process goes to the step S3061 in which the contrast computing circuit 124 computes the contrast of the electronic zoom areas while the focus lens 1102 moves. In the step S3062, there is detected the closest derived area in which the position to obtain the peak of the contrast is closest. In the step S3063, the focus is set up to the further side (that is, the focus lens 1102 is disposed to the position indicated by the reference code “A” in FIG. 8) than the closest derived area in the range wherein the closest derived area of two or more derived areas is in the permissible circle of confusion (the flowchart of FIG. 9 describes “focus is driven backward by the corresponding one permissible circle of confusion”). In the step S307, there is performed the photography for the entire photographic area including two or more derived areas, and the processing of this flowchart is terminated.

When the CPU 100 executes the above-mentioned processing, it is possible to perform the photography for both the electronic zoom areas (derived areas) through suppressing out-of-focus for both the derived areas by displacing the focus lens at the position of the reference code “A” shown in FIG. 8 and in addition through implementing evenness of out-of-focus for both the derived areas, even if the focus positions of two derived areas are mutually different as shown in FIG. 8.

In the event that the aperture opens when the focus is set up to the position of the reference code “A” shown in FIG. 8, it is possible to obtain an image with less out-of-focus because the depth of field (Correspond to the permissible circle of confusion) can be deepened by stopping the aperture.

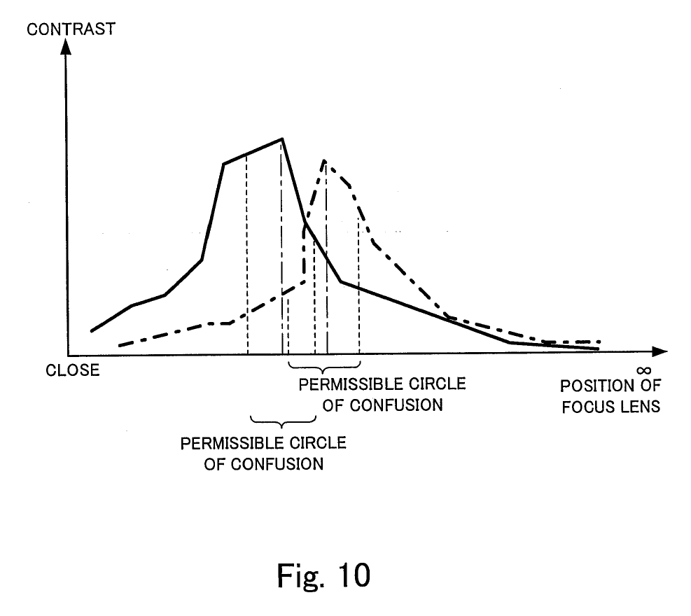

FIG. 10 is an explanatory view useful for understanding an example where individual permissible circles of two derived areas overlap each other in a state that an aperture opens before stopping down.

In this case, there is no need of stopping the aperture. The set up of focusing on the overlapped area makes it possible to obtain an image with focusing on both the derived areas. As shown in FIG. 8, in a case where there is no overlapped area, performing a photography through disposing the focus lens at the position of the reference code “A” makes it possible to obtain an image wherein out-of-focus of the images on both the derived areas is suppressed somewhat. Stopping of the aperture at the state of FIG. 8 makes it possible to obtain an image with less out-of-focus through expanding the focus range on both the derived areas.

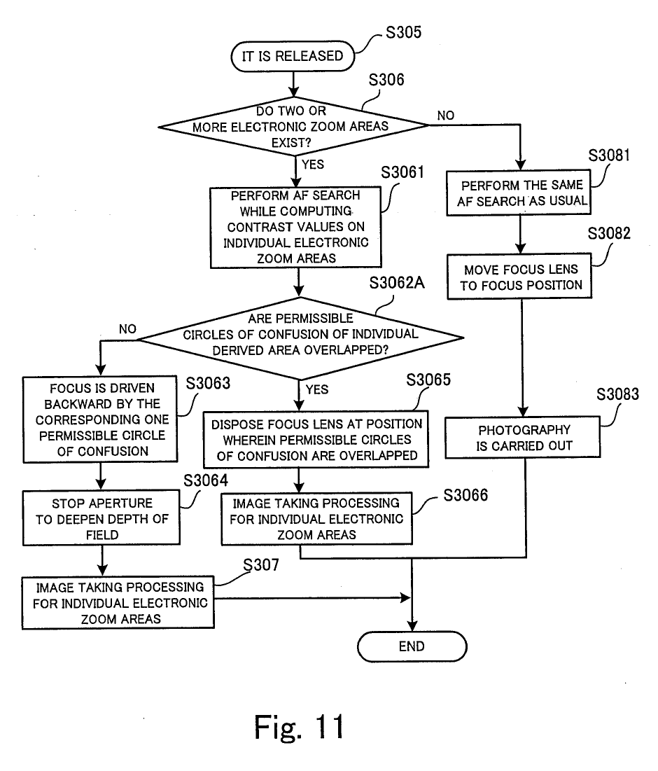

FIG. 11 is an explanatory view useful for understanding processing of the CPU 100.

Also in the present embodiment, there is adopted a digital camera having the external appearance shown in FIG. 1 and the internal structure shown in FIG. 2. It is assumed that an aperture is disposed in the image taking optical system of the digital camera of FIG. 2 and there is prepared an aperture driving section for adjusting the diameter of the aperture.

FIG. 11 shows a flowchart similar to FIG. 9.

FIG. 11 is the same as FIG. 9 in processing excepting that processing of the step S3062A is altered and processing of the step S3064 to the step S3066 is added.

The step S3062A is added after the step S3061. In the step S3062A, it is judged whether the permissive circles of confusion of individual derived areas are overlapped. In the step S3062A, when it is decided that the permissive circles of confusion of individual derived areas are not overlapped, the process goes to the step S3063 in which the focus lens is moved to the position indicated by the reference code “A” shown in FIG. 8. In the step S3064, the aperture driving section stops the aperture to deepen the depth of field. In the step S307, the photography is carried out.

In the step S3062A, when it is decided that the permissive circles of confusion of individual derived areas are overlapped, the focus lens is disposed at the position wherein the permissive circles of confusion of individual derived areas are overlapped, and the process goes to the step S3066 in which the photography is carried out, and processing of this flowchart is terminated.

Thus, according to the present embodiment, it is possible to suppress out-of-focus on the individual derived areas, even if the focus points on the derived areas are different from one another. In the event that the permissive circles of confusion of individual derived areas are overlapped, setting up of the focus on the overlapped area makes it possible to obtain an image with focus on the individual derived area.

Hereinafter, there will be explained briefly a white balance adjustment for the first image taking apparatus and the second image taking apparatus.

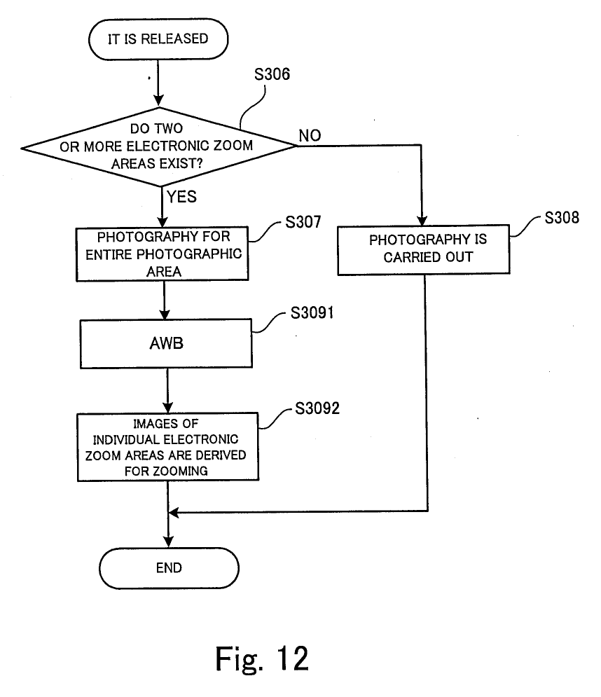

FIG. 12 is an explanatory view useful for understanding white balance processing of an image processing circuit 122.

When the release button 10 is depressed, the process goes to the step S306 in which it is judged whether there are two or more electronic zoom areas. In the step S306, when it is decided that two or more electronic zoom areas do not exist, the process goes to the step S308 in which usual image taking processing is performed, and the processing of this flowchart is terminated.

In the step S306, when it is decided that two or more electronic zoom areas exist, the process goes to the step S307 in which image taking process starts. In the step S3091, the image processing circuit 122 performs the white balance adjustment for the image which is displayed on the main screen, and the process goes to the step S3092 in which images of individual electronic zoom areas are derived for zooming. Thus, the processing of this flowchart is terminated.

Thus, the use of the white balance of the whole image on the main screen makes it possible to obtain tint of the zoom image of the derived area onto which tint of the whole image is reflected.

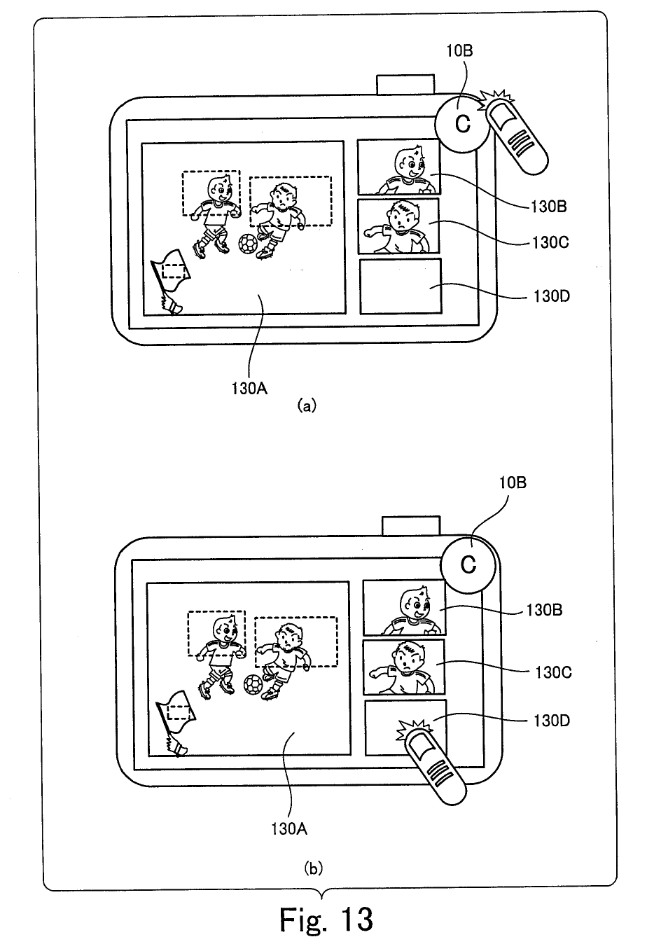

FIG. 13 is an explanatory view useful for understanding an example where a digital camera has a function of custom white balance (CWB).

The digital camera of FIG. 13 has the same external appearance as FIG. 1 and the substantially same internal structure as FIG. 2. It is noted that the number of sub-screens is increased from two to three, and the image processing circuit 122 has a custom white balance (CWB) adjustment function.

As seen from FIG. 13, on the back of the digital camera, there are provided a CWB switch 10B, and in addition three sub-screens of the first sub-screen 130B, a second sub-screen 130C and a third sub-screen 130D. The third sub-screen 130D is used for the setting of a standard color for the white balance adjustment. According to the example of FIG. 13, there are set three derived areas in the main screen 130A. And after the images are displayed on the first sub-screen 130B, the second sub-screen 130C and the third sub-screen 130D, respectively, when the CWB switch 10B is depressed and in addition when the third sub-screen 130D is touched, the image on the third sub-screen 130D is used as the standard color for the white balance adjustment. According to this example, the image processing circuit 122 is notified of the position coordinate of the image of the portion displayed on the third sub-screen 130D, and the image processing circuit 122 performs the white balance adjustment taking the white color of the white flag at the coordinate position as the standard color. According to this example, the standard color storage section referred to in the present invention is included in the image processing circuit 122.

In other words, the image processing circuit 122 having the white balance adjustment function is provided with the standard color storage section that stores the standard color to perform the white balance adjustment in accordance with the image displayed on the third sub-screen 130D.

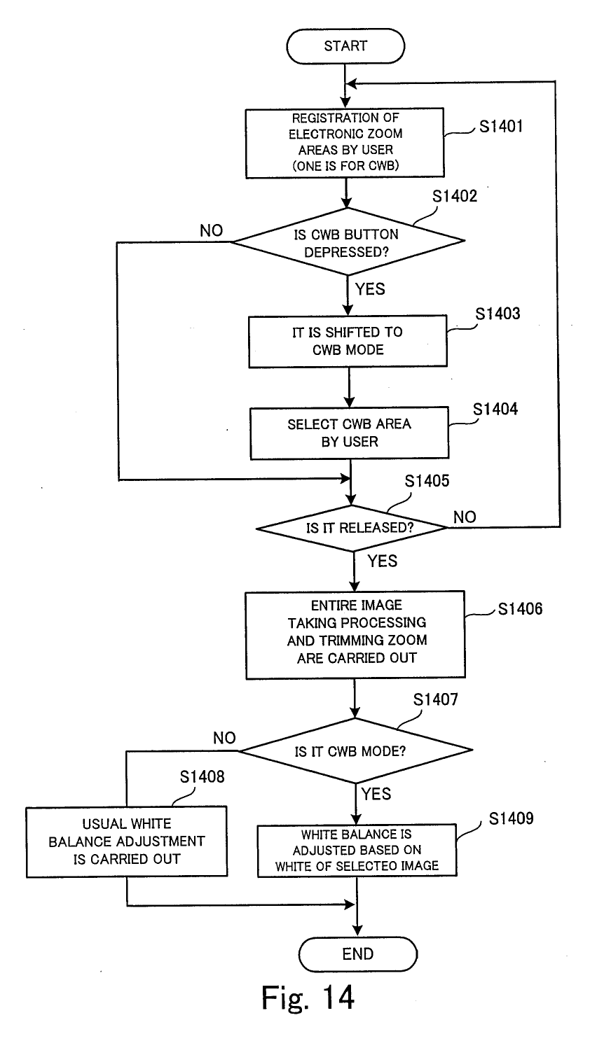

FIG. 14 is a flowchart useful for understanding procedure of image taking processing of the CPU 100 where the custom white balance is carried out.

The CPU 100 starts the operation when the release button is depressed on a half-depression basis.

In the step S1401, three derived areas shown in FIG. 13 are set up and the images of the derived areas are subjected to zoom processing, and then the images subjected to zoom processing are displayed on three sub-screens of the first sub-screen 130B, the second sub-screen 130C and the third sub-screen 130D, respectively. In the step S1402, it is judged whether the CWB switch 10B is depressed. In the step S1402, when it is decided that the CWB switch 10B is not depressed, the process goes to the step S1405 wherein the operation of release button 10A is waited for. In the step S1402, when it is decided that the CWB switch 10B is depressed, the process goes to the step S1403 in which it is shifted to the CWB mode. In the step S1404, there is selected an image to be taken as the standard color for the white balance in response to the touch operation of any one of the first sub-screen 130B, the second sub-screen 130C and the third sub-screen 130D.

In the step S1405, it is judged whether the release button 10A is depressed. In the step S1405, when it is decided that the release button 10A is not depressed, the process returns to the step S1401 to repeat the processing of the step S1401 to the step S1405. In the step S1405, when it is decided that the release button 10A is depressed, the process goes to the step S1406 in which the entire image taking processing and trimming zoom are carried out. In the step S1407, it is judged whether it is the CWB mode. When it is decided that it is not the CWB mode, the process goes to the step S1408 in which the usual white balance adjustment is carried out. Thus, the processing of this flowchart is terminated. In the step S1407, when it is decided that it is the CWB mode, the process goes to the step S1409 in which the white balance is adjusted based on the white of the image selected in the step S1404.

This arrangement makes it possible to perform the custom white balance adjustment with a simple operation.

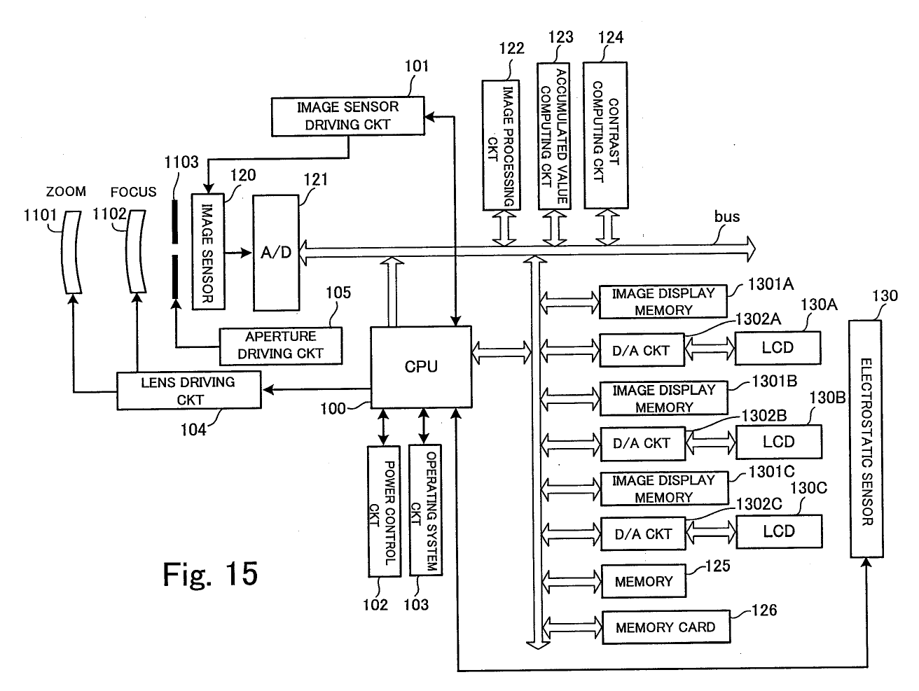

FIG. 15 is an explanatory view useful for understanding a structure of a digital camera having two or more image taking sections referred to in the present invention.

It is assumed that the digital camera of FIG. 15 has the same external appearance as that shown in FIG. 1. The structure of FIG. 15 is the same as that of FIG. 2 excepting that an aperture 1103 and an aperture driving circuit 105 are added.

As mentioned above, according to the digital cameras of the first embodiment and the second embodiment, there is prepared the image sensor 120 that is of high pixel number and high frame rate. This feature makes it possible to perform a high speed multi-page. Thus, in the use of the high speed multi-page, it is possible to obtain clear images regarding both the entire image and the individual derived images in such a manner that in the first photography, a focus is set up on the center of the subject and the entire exposure is adjusted to perform the photography for the entire image, in the second photography, a focus is set up on the derived area displayed on the first sub-screen 130B and the exposure for the derived area is adjusted to perform the photography, and in the third photography, a focus is set up on the derived area displayed on the second sub-screen 130C and the exposure for the derived area is adjusted to perform the photography.

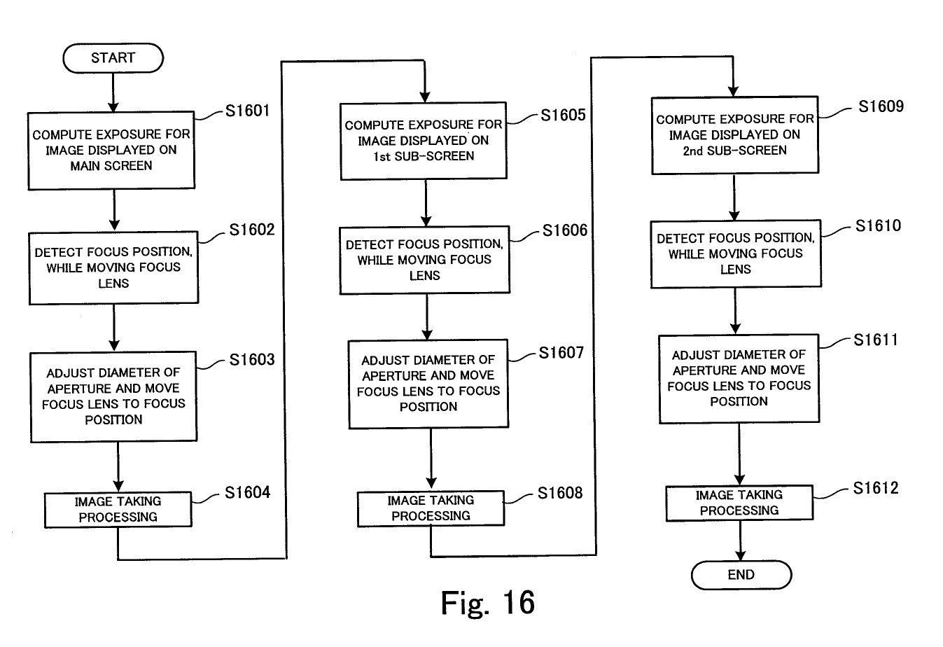

FIG. 16 is a flowchart useful for understanding processing of the CPU 100 where a high speed multi-page is carried out with the digital camera of FIG. 15.

When the release button 10 is depressed, the CPU 100 starts the processing of the flowchart of FIG. 16.

In the step S1601, the accumulated value computing circuit 123 computes the exposure for the image displayed on the main screen. In the step S1602, the contrast computing circuit 124 detects the focus position, while the lens driving circuit 104 moves the focus lens 1102. In the step S1603, the aperture driving circuit 105 adjusts the diameter of the aperture 1103 and the lens driving circuit 104 moves the focus lens 1102 to the focus position. In the step S1604, the image taking processing is carried out to obtain image data representative of an image, and the image data thus obtained is stored in a memory card.

In the step S1605, the accumulated value computing circuit 123 computes the exposure for the image displayed on the first sub-screen 130B. In the step S1606, the contrast computing circuit 124 detects the focus position, while the lens driving circuit 104 moves the focus lens 1102. In the step S1607, the aperture driving circuit 105 adjusts the diameter of the aperture 1103 and the lens driving circuit 104 moves the focus lens 1102 to the focus position. In the step S1608, the image taking processing for the image displayed on the first sub-screen 130B is carried out to obtain image data representative of an image, and the image data thus obtained is stored in a memory card.

In the step S1609, the accumulated value computing circuit 123 computes the exposure for the image displayed on the second sub-screen 130C. In the step S1610, the contrast computing circuit 124 detects the focus position, while the lens driving circuit 104 moves the focus lens 1102. In the step S1611, the aperture driving circuit 105 adjusts the diameter of the aperture 1103 and the lens driving circuit 104 moves the focus lens 1102 to the focus position. In the step S1612, the image taking processing for the image displayed on the second sub-screen 130C is carried out to obtain image data representative of an image, and the image data thus obtained is stored in a memory card.

The execution of the above-mentioned processing makes it possible to obtain the clear image since the photography for an image displayed on the main screen, an image displayed on the first sub-screen, and an image displayed on the second sub-screen is carried out through three times of multi-page in the state of the just focus.

According to the present embodiment, plural image taking sections comprises: the CPU 100; the image sensor driving circuit 101; the image sensor 120; the aperture driving circuit 105; the aperture 1103; the lens driving circuit 104; and the focus lens 1102.

As mentioned above, according to the present invention, it is possible to implement an image display unit having a main screen and one or more sub-screens, wherein two or more zoom areas are designated, and images of the designated zoom areas are displayed on the sub-screens, an image taking apparatus having such an image display unit, and an image display method.

While the present invention has been described with reference to the particular illustrative embodiments, it is not to be restricted by those embodiments but only by the appended claims. It is to be appreciated that those skilled in the art can change or modify the embodiments without departing from the scope and spirit of the present invention.

What is claimed is:

1. An image display unit having a main screen and one or more sub-screens, the image display unit comprising:
a first display section that displays images on the main screen;
a designating section that designates a desired place on the main screen by an operation; and
a second display section that displays on one of the sub-screens an image in a derived area including the place designated by the designating section, of the images displayed on the main screen.

2. The image display unit according to claim 1, wherein the main screen is a touch panel, and the designating section designates a touched place on the main screen through a finger touch on the main screen.

3. The image display unit according to claim 2, wherein the first display section indicates on the image displayed on the main screen the derived area displayed on the sub-screen, of the image displayed on the main screen.

4. The image display unit according to claim 3, wherein the designating section designates movement and enlargement/reduction of the derived area in accordance with touch and movement of a finger on the derived area,
the first display section indicates on the image displayed on the main screen the derived area after movement or enlargement/reduction in accordance with movement or enlargement/reduction of the derived area, and
the second display section displays the image in the derived area after movement and enlargement/reduction in accordance with movement or enlargement/reduction of the derived area.

5. The image display unit according to claim 3, wherein the image display unit has a plurality of sub-screens each of which is a touch panel, and the second display section displays on the sub-screen designated by a finger touch of the plurality of sub-screens an image in the derived area including the place designated by the designating section, of the images displayed on the main screen.

6. An image display unit having a main screen and one or more sub-screens, the image display unit comprising:
a first display section that displays images on the main screen;
a face detection section that detects a face in an image displayed on the main screen; and
a second display section that displays on one of the sub-screens an image in a derived area including the face detected by the face detection section, of the images displayed on the main screen.

7. An image taking apparatus that forms an image of a subject on an imaging device to create an image representative of the subject, wherein the image taking apparatus has a main screen and one or more sub-screens, the image taking apparatus comprising:
a first display section that displays images created by the imaging device on the main screen;
a designating section that designates a desired place on the main screen by an operation; and
a second display section that displays on one of the sub-screens an image in a derived area including the place designated by the designating section, of the images displayed on the main screen.

8. The image taking apparatus according to claim 7, wherein the main screen is a touch panel, and the designating section designates a touched place on the main screen through a finger touch on the main screen.

9. The image taking apparatus according to claim 8, wherein the first display section indicates on the image displayed on the main screen the derived area displayed on the sub-screen, of the image displayed on the main screen.

10. The image taking apparatus according to claim 8, wherein the designating section designates movement and enlargement/reduction of the derived area in accordance with touch and movement of a finger on the derived area,
the first display section indicates on the image displayed on the main screen the derived area after movement or enlargement/reduction in accordance with movement or enlargement/reduction of the derived area, and
the second display section displays the image in the derived area after movement and enlargement/reduction in accordance with movement or enlargement/reduction of the derived area.

11. The image taking apparatus according to claim 8, wherein the image display unit has a plurality of sub-screens each of which is a touch panel, and the second display section displays on the sub-screen designated by a finger touch of the plurality of sub-screens an image in the derived area including the place designated by the designating section, of the images displayed on the main screen.

12. An image taking apparatus that forms an image of a subject on an imaging device to create an image representative of the subject, wherein the image taking apparatus has a main screen and one or more sub-screens, the image taking apparatus comprising:
a first display section that displays images created by the imaging device on the main screen;
a face detection section that detects a face in an image displayed on the main screen; and
a second display section that displays on one of the sub-screens an image in a derived area including the face detected by the face detection section, of the images displayed on the main screen.

13. The image taking apparatus according to claim 7, wherein the image taking apparatus has two or more sub-screens, and the image taking apparatus further comprises a focus adjusting section that performs focusing on two or more derived areas displayed on said two or more sub-screens, respectively, to focus on the closest derived area of said two or more derived areas.

14. The image taking apparatus according to claim 12, wherein the image taking apparatus has two or more sub-screens, and the image taking apparatus further comprises a focus adjusting section that performs focusing on two or more derived areas displayed on said two or more sub-screens, respectively, to focus on the closest derived area of said two or more derived areas.

15. The image taking apparatus according to claim 7, wherein the image taking apparatus has two or more sub-screens, and the image taking apparatus further comprises a focus adjusting section that performs focusing on two or more derived areas displayed on said two or more sub-screens, respectively, to focus on a distance offering an equivalent circle of confusion on the closest derived area and the farthest derived area of said two or more derived areas.

16. The image taking apparatus according to claim 12, wherein the image taking apparatus has two or more sub-screens, and the image taking apparatus further comprises a focus adjusting section that performs focusing on two or more derived areas displayed on said two or more sub-screens, respectively, to focus on a distance offering an equivalent circle of confusion on the closest derived area and the farthest derived area of said two or more derived areas.

17. The image taking apparatus according to claim 7, wherein the image taking apparatus has two or more sub-screens, and the image taking apparatus further comprises a focus adjusting section that performs focusing on two or more derived areas displayed on said two or more sub-screens, respectively, to focus on a distance farther than the closest derived area of said two or more derived areas in a range that the closest derived area is in a predetermined permissible circle of confusion.

18. The image taking apparatus according to claim 12, wherein the image taking apparatus has two or more sub-screens, and the image taking apparatus further comprises a focus adjusting section that performs focusing on two or more derived areas displayed on said two or more sub-screens, respectively, to focus on a distance farther than the closest derived area of said two or more derived areas in a range that the closest derived area is in a predetermined permissible circle of confusion.

19. The image taking apparatus according to claim 7, wherein the image taking apparatus has two or more sub-screens, and the image taking apparatus further comprises an aperture adjusting section that adjusts an aperture so that said two or more derived areas is in a predetermined permissible circle of confusion.

20. The image taking apparatus according to claim 12, wherein the image taking apparatus has two or more sub-screens, and the image taking apparatus further comprises an aperture adjusting section that adjusts an aperture so that said two or more derived areas is in a predetermined permissible circle of confusion.

21. The image taking apparatus according to claim 7, wherein the image taking apparatus further comprises a white balance adjustment section that adjusts a white balance in accordance with an image displayed on the main screen.

22. The image taking apparatus according to claim 12, wherein the image taking apparatus further comprises a white balance adjustment section that adjusts a white balance in accordance with an image displayed on the main screen.

23. The image taking apparatus according to claim 7, wherein the image taking apparatus further comprises a standard color storage section that stores a standard color for a white balance adjustment in accordance with an image displayed on the sub-screen.

24. The image taking apparatus according to claim 12, wherein the image taking apparatus further comprises a standard color storage section that stores a standard color for a white balance adjustment in accordance with an image displayed on the sub-screen.

25. The image taking apparatus according to claim 7, wherein the image taking apparatus further comprises two or more image taking sections that focus on the main screen and said one or more sub-screens and perform photography for two or more images adjusted in exposure.

26. The image taking apparatus according to claim 12, wherein the image taking apparatus further comprises two or more image taking sections that focus on the main screen and said one or more sub-screens and perform photography for two or more images adjusted in exposure.

27. An image display method of displaying images onto a main screen and one or more sub-screens, the image display method comprising:
first display step of displaying images on the main screen;
designating step of designating a desired place on the main screen by an operation; and
second display step of displaying on one of the sub-screens an image in a derived area including the place designated in the designating step, of the images displayed on the main screen.
